(19) United States
(12) Patent Application Publication
(10) Pub. No.: US 2025/0182373 A1
(43) Pub. Date: Jun. 5, 2025

(54) COMPUTER MODEL RENDERING

(71) Applicant: HUAWEI TECHNOLOGIES CO., LTD., Shenzhen (CN)

(72) Inventors: Enrique Alberto Rosales Ruiz, Vancouver (CA); Fatemeh Teimury, Vancouver (CA); Joshua Horacsek, Maple Ridge (CA); Aria Salari, Vancouver, CA (US); Xuebin Qin, Burnaby (CA); Adi Moshe Bar-Lev, Toronto (CA); Xiaoqiang Zhe, Shanghai (CN); Ligang Liu, Hangzhou (CN)

(21) Appl. No.: 18/524,487

(22) Filed: Nov. 30, 2023

(51) Int. Cl. G06T 15/04

(52) U.S. Cl. CPC G06T 15/04

(57) ABSTRACT

Respective positions of a light source and an observer are identified relative to a macro surface. Based on the positions of the light source and the observer, respective positions of a first microfacet and a second microfacet are determined. A vector c bisects an angle subtended by the first and second microfacets. The positions of the first and second microfacets are positions in which, based on multiple orientations of c, light travelling from the light source to the macro surface is reflected by the first microfacet toward the second microfacet, and then by the second microfacet toward the observer. Based on the positions of the first and second microfacets, a multi-scattering factor is determined. Based on the multi-scattering factor, a computer model is rendered.

### FIELD

The present disclosure relates to computer graphics processing and in particular to methods and devices for rendering a computer model.

### BACKGROUND

Material representation is a fundamental concept in computer graphics and is a critical component of all photo-realistic offline and real-time renderers. In order to achieve a realistic image, a shading model needs to approximate the interaction of light with different materials, which depends on the materials' physical properties. These models are known as physically-based shaders, and commonly rely on microfacet theory as a basis for their underlying mathematical formulation. At its core, microfacet theory assumes that the microscopic surface of a material is composed of small planar mirrors, each acting as a perfect specular reflector. Modelling the interaction of light at the microscopic level is challenging, and thus most models resort to some form of simplification of the microfacet geometry. These simplifications lead to computationally-tractable shading models.

Modern shading models are usually based on the Cook-Torrance (CT) model or its variants. The CT model may be considered an infrastructure of modern physically-based rendering systems, and allows materials to be represented as a composition of individual lobes. Each lobe represents a different light-matter interaction, and most of them can be approximated using the CT model.

A popular version of the CT model is the Ground Glass X (GGX) model which is the most popular model for computing the distribution term (D) in the CT model. One key component of the GGX model is the geometric term (G) from the CT model which accounts for localized occlusion among microfacets. The GGX model multiplicatively splits the geometric term into two terms. Loosely speaking, the first term is the probability that light travelling towards a given microfacet is not blocked by some other microfacet before the light reaches the given microfacet, and the second term represents the probability of the reflected rays not being blocked by another microfacet after reflection. This naturally excludes the case in which light travels between multiple microfacets (i.e., undergoes multi-scattering) before reaching the eye. As a result, with the GGX model, materials with relatively high roughness appear darker than they should.

Recently, several efforts have been made to incorporate multi-scattering into microfacet models. Despite the analytical solutions of these attempts, they fail to produce physically-accurate results for materials with relatively high roughness.

### SUMMARY

According to first aspect of the disclosure, there is provided a method of rendering a computer model, comprising: identifying, relative to a macro surface, respective positions of a light source and an observer; determining, based on the positions of the light source and the observer, respective positions of a first microfacet and a second microfacet, wherein: a vector c bisects an angle subtended by the first and second microfacets; and the positions of the first and second microfacets are positions in which, based on multiple orientations of c, light travelling from the light source to the macro surface is reflected by the first microfacet toward the second microfacet, and then by the second microfacet toward the observer; determining, based on the positions of the first and second microfacets, a multi-scattering factor; and rendering the computer model based on the multi-scattering factor. As a result, specular artifacts may be avoided when rendering the model.

The method may further comprise determining, based on the positions of the light source and the observer, a single-scattering factor. Rendering the model may comprise rendering the model based on the single-scattering factor and the multi-scattering factor.

Rendering the model may comprise: determining a sum of the single-scattering factor and the multi-scattering factor; and rendering the model based on the sum.

The positions of the first and second microfacets may be such that light travelling from the light source to the macro surface is reflected by the first microfacet toward the second microfacet, and then by the second microfacet toward the observer, and is not reflected by any other microfacet.

Respective rear surfaces of the first and second microfacets may be assumed to be transparent to light such that, for each of the first and second microfacets, light incident on the rear surface is assumed to pass through the microfacet. The positions of the first and second microfacets may be positions in which light travelling from the light source to the macro surface is reflected by a front surface of the first microfacet toward the second microfacet, and then by a front surface of the second microfacet toward the observer, wherein the front surfaces of the first and second microfacets are opposite the respective rear surfaces of the first and second microfacets. As a result, rendering the model may be less computationally expensive than other methods, since the equations required to compute the positions of the first and second microfacets may be simplified.

Determining the multi-scattering factor may comprise: determining D_{I}, G_{I}, and F_{I}, wherein D_{I} is a distribution factor of microfacets on the macro surface, G_{I} is an attenuation factor of microfacets on the macro surface, and F_{I} is a reflectance factor of the macro surface; and determining the multi-scattering factor is based on D_{I}, G_{I}, and F_{I}.

Determining the multi-scattering factor may comprise determining

$$\frac{{D}_{I} * {G}_{I} * {F}_{I}}{2 {θ}_{vc}} ,$$

wherein: light transmitted from the light source and reflected by the macro surface toward the observer defines a vector v extending from the macro surface and toward the observers; and θ_{vc} is the angle subtended by c and v.

According to some embodiments,

$${D}_{I} = \frac{{α}^{2}}{{π ( {cos ( {θ}_{m} )}^{2} ( {α}^{2} - 1 ) + 1 )}^{2}} ,$$

wherein: α is a roughness of the macro surface; and θₘ is half the angle subtended by the first and second microfacets.

According to some embodiments,

$${G}_{I} = 1 - max ( 0 , \frac{sin ( {θ}_{vc} - {θ}_{m} )}{sin ( {θ}_{vc} + {θ}_{m} )} ) ,$$

wherein: light transmitted from the light source and reflected by the macro surface toward the observer defines a vector v extending from the macro surface and toward the observer; θ_{vc} is the angle subtended by c and v, and θₘ is half the angle subtended by the first and second microfacets.

According to some embodiments, F_{I}=F², wherein F is a Fresnel reflectance of the macro surface. As a result, the computation cost of the reflectance factor may be reduced.

The positions of the first and second microfacets may be positions in which, based on the multiple orientations of c, light travelling from the light source to the macro surface is reflected by the first microfacet toward the second microfacet and in a direction parallel to the macro surface, and then by the second microfacet toward the observer.

The multiple orientations of c may consist of all orientations of c.

According to a further aspect of the disclosure, there is provided a method of rendering a computer model, comprising: identifying, relative to a macro surface, respective positions of a light source and an observer; determining, based on the positions of the light source and the observer, respective positions of a first microfacet and a second microfacet, wherein: respective rear surfaces of the first and second microfacets are assumed to be transparent to light such that, for each of the first and second microfacets, light incident on the rear surface is assumed to pass through the microfacet; and the positions of the first and second microfacets are positions in which light travelling from the light source to the macro surface is reflected from a front surface of the first microfacet toward the second microfacet, and then from a front surface of the second microfacet toward the observer, wherein the front surfaces of the first and second microfacets are opposite the respective rear surfaces of the first and second microfacets; determining, based on the positions of the first and second microfacets, a multi-scattering factor; and rendering the computer model based on the multi-scattering factor.

According to a further aspect of the disclosure, there is provided a non-transitory computer-readable medium comprising computer program code configured, when executed by a one or more processors, to cause the one or more processors to render a computer model according to any of the above-described methods.

According to a further aspect of the disclosure, there is provided a computing device comprising: a graphics processing unit; and a computer-readable medium comprising computer program code configured, when executed by the graphics processing unit, to cause the graphics processing unit to render a computer model according to any of the above-described methods.

This summary does not necessarily describe the entire scope of all aspects. Other aspects, features, and advantages will be apparent to those of ordinary skill in the art upon review of the following description of specific embodiments.

### DRAWINGS

Embodiments of the disclosure will now be described in detail in conjunction with the accompanying drawings of which:

FIG. 1 is a schematic diagram of a computing device operable to render a computer model, according to an embodiment of the disclosure;

FIG. 2 is a schematic diagram of microfacets reflecting light incident on a macro surface;

FIG. 3 is a schematic diagram of a V-groove reflecting light incident on a macro surface, according to an embodiment of the disclosure;

FIG. 4 is a schematic diagram of two separated microfacets reflecting light at the same angle as their corresponding V-groove, according to an embodiment of the disclosure;

FIG. 5 is a schematic diagram of a micro surface profile reflecting incident light, according to an embodiment of the disclosure; and

FIG. 6 illustrates the combination of a single-reflection CT model and a second-reflection CT-based model, according to an embodiment of the disclosure.

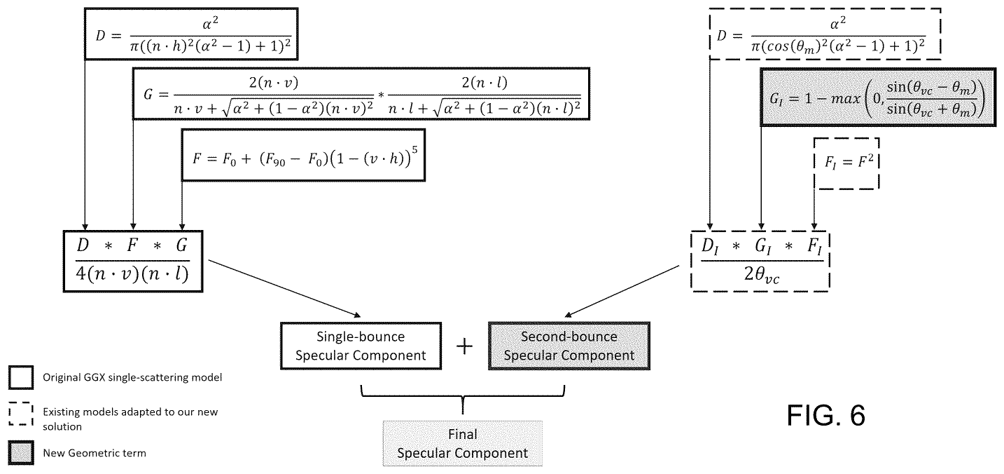

### DETAILED DESCRIPTION

The present disclosure seeks to provide novel methods and devices for rendering a computer model. While various embodiments of the disclosure are described below, the disclosure is not limited to these embodiments, and variations of these embodiments may well fall within the scope of the disclosure which is to be limited only by the appended claims.

The CT model describes the interaction between light and microfacet geometry with the following equation:

$$f = \frac{D G F}{4 ( n \cdot v ) ( n \cdot l )}$$

where n, v, and l represent the normal, view, and light direction vectors, respectively, and D, G, and F represent the normal distribution, the geometric attenuation, and the Fresnel reflectance terms, respectively. As described above, a major limitation of the classical microfacet model is that the G term ignores cases in which light may be reflected by multiple microfacets of the surface before ultimately leaving the surface (this is known as multiple-scattering, or multi-scattering).

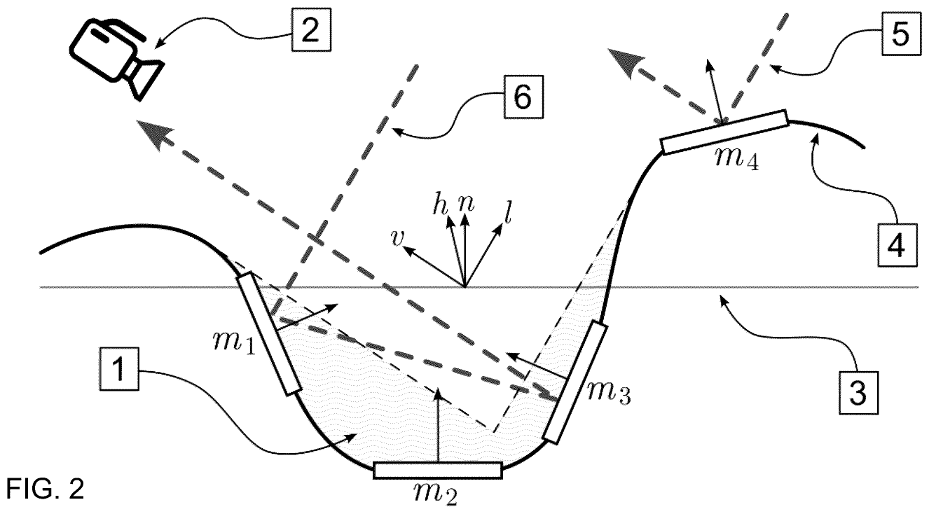

As can be seen in FIG. 2, the material's surface 3 includes a theoretical irregular surface 4 formed by the microfacets m₁, m₂, m₃, and m₄. Microfacets m₁ and m₂ are illuminated by the incident light 6 but are not visible from the point of view of the camera 2 (i.e., the observer), and microfacet m₃ is visible from the camera 2 but is occluded from the incident light 6. The hatched area 1 represents the space that is occluded by the incident light 6, the camera 2, or both. In a single-scattering approach, a light ray hitting a flat surface has an angle of reflection equal to its angle of incidence. Thus, a surface is only able to transmit energy from a light direction l to a camera's direction v if its normal is aligned with a vector that lies in-between the light and view vectors, l and v. This vector is known as the half vector h. In this case, only microfacet m₄ is aligned with half vector h. Accounting for a second reflection (i.e., multi-scattering) considers the fact that light may be reflected from microfacet m₁ to microfacet m₃ and then to the camera 2 along vector v (this is represented by the second-reflection light path 6).

As explained above, the typical formulation of G in the CT model does not account for multi-scattering, since occluded microfacets are ignored. Therefore, materials with relatively high roughness (for example, from 0.5 to 1) may appear darker than expected due to the energy “lost” from this phenomenon.

According to embodiments of the disclosure, an empirically-tuned shading model is described and which compensates for the missing energy in the CT model's single-reflection approximation. As described in further detail below, we start by defining a V-groove cavity model with fewer geometric restrictions than previous methods, and extending the light transfer by using an asymmetrical light transport approach. This novel geometric model for two-reflection scattering may be:
easy to implement, since the approximation comprises an additive term that relies on simple arithmetic to be computed;
real-time capable (most other multi-scattering methods require some form of Monte-Carlo simulation that adds variance and therefore is more computationally intensive); and
relatively free of noise and artifacts (e.g., fireflies), since no Monte-Carlo simulations are required.

The geometric model described herein may function with the CT model and its GGX variant. The solution may approximate the multi-scattering contribution with a closed-form formulation, and may be added to the GGX single-scattering term. This allows the model to be used in all CT-based lobes and other applications in which there is a complex interaction with light due to multiple scattering. The model may be compatible with all CT-GGX-based shaders.

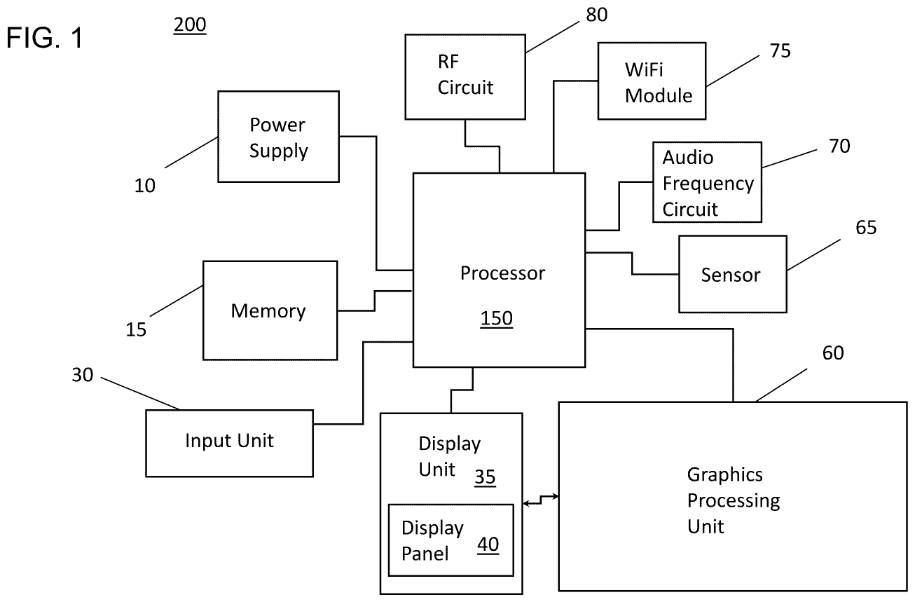

Embodiments of the disclosure may generally be used in connection with computer graphics processing involving shaders, for example as performed during mobile device and desktop computer gaming. Furthermore, methods according to embodiments of the disclosure may be performed by electronic computing devices, and embodiments of the disclosure also include electronic computing devices configured to perform any of the methods described herein. An example of such an electronic computing device will now be described in further detail in connection with FIG. 1.

In some embodiments, the computing device may be a portable computing device, such as a tablet computer or a laptop with one or more touch-sensitive surfaces (for example, one or more touch panels). It should be further understood that, in other embodiments of this disclosure, the computing device may alternatively be a desktop computer with one or more touch-sensitive surfaces (for example, one or more touch panels).

For example, as shown in FIG. 1, the computing device according to embodiments of this disclosure may be a computing device 200. The following specifically describes an embodiment of using computing device 200 as an example. It should be understood that computing device 200 shown in the figure is merely an example of possible computing devices that may perform the methods described herein, and computing device 200 may have more or fewer components than those shown in the figure, or may combine two or more components, or may have different component configurations. Various components shown in the figure may be implemented in hardware, software, or a combination of hardware and software that include one or more signal processing and/or application-specific integrated circuits.

As shown in FIG. 1, computing device 200 may specifically include components such as one or more processors 150, a radio frequency (RF) circuit 80, a memory 15, display unit 35, one or more sensors 65 such as a fingerprint sensor, a wireless connection module 75 (which may be, for example, a Wi-Fi® module), an audio frequency circuit 70, an input unit 30, a power supply 10, and a graphics processing unit (GPU) 60. These components may communicate with each other by using one or more communications buses or signal cables (not shown in FIG. 1). A person skilled in the art may understand that a hardware structure shown in FIG. 1 does not constitute a limitation on computing device 200, and computing device 200 may include more or fewer components than those shown in the figure, may combine some components, or may have different component arrangements.

Processor 150 is a control center of computing device 200. Processor 150 is connected to each part of computing device 200 by using various interfaces and lines, and performs various functions of computing device 200 and processes data by running or executing an application stored in memory 15, and invoking data and an instruction that are stored in memory 15. In some embodiments, processor 150 may include one or more processing units. An application processor and a modern processor may be integrated into processor 150. The application processor mainly processes an operating system, a user interface, an application, and the like, and the modern processor mainly processes wireless communication. It should be understood that the modern processor does not have to be integrated in processor 150. For example, processor 150 may be a Kirin chip 970 manufactured by Huawei Technologies Co., Ltd. In some other embodiments of this disclosure, processor 150 may further include a fingerprint verification chip, configured to verify a collected fingerprint.

RF circuit 80 may be configured to receive and send a radio signal in an information receiving and sending process or a call process. Specifically, RF circuit 80 may receive downlink data from a base station, and then send the downlink data to processor 150 for processing. In addition, RF circuit 80 may further send uplink-related data to the base station. Generally, RF circuit 80 includes but is not limited to an antenna, at least one amplifier, a transceiver, a coupler, a low noise amplifier, a duplexer, and the like. In addition, RF circuit 80 may further communicate with another device through wireless communication. The wireless communication may use any communications standard or protocol, including but not limited to a global system for mobile communications, a general packet radio service, code division multiple access, wideband code division multiple access, long term evolution, an SMS message service, and the like.

Memory 15 is configured to store one or more applications and data. Processor 150 runs the one or more applications and the data that are stored in memory 15, to perform the various functions of computing device 200 and data processing. The one or more applications may comprise, for example, a computer game, or any other application that requires the rendering of computer graphics data for display on a display panel 40 of display unit 35. Memory 15 mainly includes a program storage area and a data storage area. The program storage area may store the operating system, an application required by at least one function, and the like. The data storage area may store data created based on use of computing device 200. In addition, memory 15 may include a high-speed random-access memory, and may further include a non-volatile memory, for example, a magnetic disk storage device, a flash memory device, or another non-volatile solid-state storage device. Memory 15 may store various operating systems such as an iOS® operating system developed by Apple Inc. and an Android® operating system developed by Google Inc. It should be noted that any of the one or more applications may alternatively be stored in a cloud, in which case computing device 200 obtains the one or more applications from the cloud.

Display unit 35 may include a display panel 40. Display panel 40 (for example, a touch panel) may collect a touch event or other user input performed thereon by the user of computing device 200 (for example, a physical operation performed by the user on display panel 40 by using any suitable object such as a finger or a stylus), and send collected touch information to another component, for example, processor 150. Display panel 40 on which the user input or touch event is received may be implemented on a capacitive type, an infrared light sensing type, an ultrasonic wave type, or the like.

Display panel 40 may be configured to display information entered by the user or information provided for the user, and various menus of computing device 200. For example, display panel 40 may further include two parts: a display driver chip and a display module (not shown). The display driver chip is configured to receive a signal or data sent by processor 150, to drive a corresponding screen to be displayed on the display module. After receiving the to-be-displayed related information sent by processor 150, the display driver chip processes the information, and drives, based on the processed information, the display module to turn on a corresponding pixel and turn off another corresponding pixel, to display a rendered computer model, for example.

For example, in this embodiment of this application, the display module may be configured by using an organic light-emitting diode (organic light-emitting diode, OLED). For example, an active matrix organic light emitting diode (active matrix organic light emitting diode, AMOLED) is used to configure the display module. In this case, the display driver chip receives related information that is to be displayed after the screen is turned off and that is sent by processor 150, processes the to-be-displayed related information, and drives some OLED lights to be turned on and the remaining OLEDs to be turned off, to display a rendered computer model.

Wireless connection module 75 is configured to provide computing device 200 with network access that complies with a related wireless connection standard protocol. Computing device 200 may access a wireless connection access point by using wireless connection module 75, to help the user receive and send an e-mail, browse a web page, access streaming media, and the like. Wireless connection module 75 provides wireless broadband internet access for the user. In some other embodiments, wireless connection module 75 may alternatively serve as the wireless connection access point, and may provide wireless connection network access for another electronic device.

Audio frequency circuit 70 may be connected to a loudspeaker and a microphone (not shown) and may provide an audio interface between the user and computing device 200. Audio frequency circuit 70 may transmit an electrical signal converted from received audio data to the loudspeaker, and loudspeaker the may convert the electrical signal into a sound signal for outputting. In addition, the microphone may convert a collected sound signal into an electrical signal, and audio frequency circuit 70 may convert the electrical signal into audio data after receiving the electrical signal, and may then output the audio data to radio frequency circuit 80 to send the audio data to, for example, a mobile phone, or may output the audio data to memory 15 for further processing.

Input unit 30 is configured to provide various interfaces for an external input/output device (for example, a physical keyboard, a physical mouse, a display externally connected to computing device 200, an external memory, or a subscriber identity module card). For example, a mouse is connected by using a universal serial bus interface, and a subscriber identity module (subscriber identity module, SIM) card provided by a telecommunications operator is connected by using a metal contact in a subscriber identity module card slot. Input unit 30 may be configured to couple the external input/output peripheral device to processor 150 and memory 15.

Computing device 200 may further include power supply module 10 (for example, a battery and a power supply management chip) that supplies power to the components. The battery may be logically connected to processor 150 by using the power supply management chip, so that functions such as charging management, discharging management, and power consumption management are implemented.

Computer device 200 further includes a GPU 60. Generally, GPU 60 is a specialized electronic circuit configured to rapidly manipulate and alter memory to accelerate the creation of images in a frame buffer intended for output to display unit 35. GPU 60 may comprise one or more shaders, such as a vertex shader. The vertex shader may be a three-dimensional shader that is executed once for each vertex of a computer model that is input to GPU 60. A purpose of a vertex shader is to transform each vertex's 3D position in virtual space to corresponding 2D coordinates at which the vertex will appear on display panel 40. The vertex shader can manipulate properties of the vertices of the computer model such as position, colour, and texture coordinates. GPU 60 may further comprise a fragment shader configured to determine the colour and other attributes of each “fragment” of the computer model, each fragment being a unit of rendering work affecting at most a single output pixel.

The following embodiments may all be implemented on an electronic device (for example, computing device 200) with the foregoing hardware structure.

According to embodiments of the disclosure, a V-groove is identified wherein the V-groove is able to transmit energy from l to v (FIG. 2) in two reflections. In materials with roughness values from 0.3 to 0.7, most of the transmitted energy is carried by the first and second reflections. Therefore, the model described herein may focus on the second reflection, and a small amount of additional energy may be added to compensate for higher-order reflections. Empirically, the second reflection accounts for most of the missing energy, avoiding the need to calculate the contribution from further reflections, and simplifying the implementation of the model.

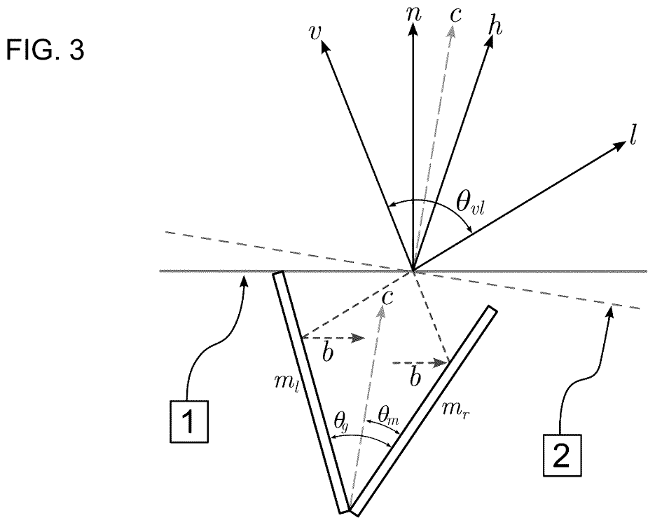

Referring to FIG. 3, a method according to the disclosure comprises identifying a microfacet mₗ that is able to reflect energy from the l vector to a horizontal reflection path b, and a microfacet mᵣ that is able to reflect energy from the same horizontal reflection path b to the vector v. Both microfacets mₗ and mᵣ form a V-groove with an opening angle θ_{g} and oriented in the direction of vector c which is the bisecting axis of the V-groove. The assumption that the reflection path b is horizontal (i.e., parallel to the macro surface 1) leads to a simplification of the equations required to compute the V-groove, allowing the computation of the V-groove (i.e., the identification of the positions of the pair of microfacets) to be less computationally expensive. The angle θ_{g} is computed as the sum of the angles of the microfacets with respect to the normal n to the surface 1:

$${θ}_{g} = \frac{π - {θ}_{vl}}{2}$$

The half vector h is the bisector of v and l, and is defined as l+v/|l+vll. Similarly, the vector c is the bisector of n (the normal vector perpendicular to the surface 1). Given the geometric construction, the light transport occurs in a plane, so the V-groove's orientation is defined as a vector c that represents the bisector of the V-groove. This vector is computed as the bisector between the surface's normal n and the half vector h as follows:

$$c = \frac{h + n}{‖ h + n ‖}$$

The angle formed by either microfacet and c is denoted as θₘ and is computed with respect to θᵥₗ (the angle between v and l) as follows:

$${θ}_{m} = \frac{π - {θ}_{vl}}{4}$$

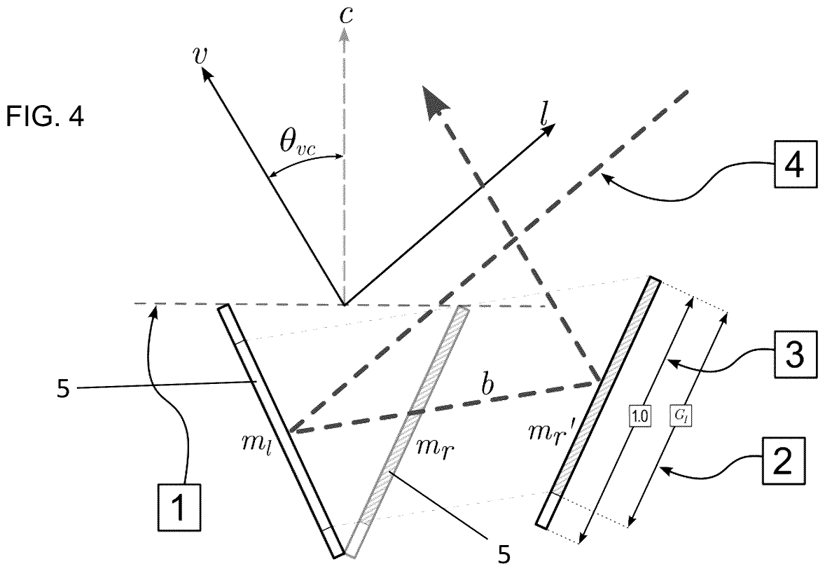

By defining the parameters of the system in terms of the vector c (i.e., rotating the V-groove cavity, and the light and view vectors, l and v, to align c with the surface normal n), we arrive at the schematic shown in FIG. 4. As can be seen, surface 1 is now the plane perpendicular to c. The goal is to find the term G_{I} that represents the percentage of energy that is able to reflect twice inside the V-groove and exit the V-groove in the direction v. Furthermore, mₗ and mᵣ are now of unitary lengths and their respective hatched regions 5 represent the portions of mₗ and mᵣ that are positioned to reflect light in the direction v. Microfacets mₗ and mᵣ are therefore defined as asymmetrical in terms of their light transport, meaning that they are reflective from inside the V-groove and transparent from outside the V-groove. Strictly speaking, asymmetrical light transport is not physically-based; there is no existing material that exhibits such behavior. However, this assumption enables us to indirectly compute a symmetrical light transport that is indeed physically plausible. As seen in FIG. 4, this is equivalent to the assumption that the microfacets mₗ and mᵣ are symmetrical but not connected to each other at the center of a unitary circle. Thus, the microfacets mₗ and mᵣ may be at any distance from each other and still transmit energy depending on their respective orientations. Therefore, for the correct microfacet mᵣ, there may exist a corresponding distant microfacet m_{r′}with the same orientation lying in a position along the path of reflection b that casts no shadow on mₗ.

Moreover, this implies that the geometric term G_{I} is unidirectional because it only accounts for occlusion from v. Therefore, the second reflection approximation is brighter than the actual second reflection because it assumes that the microfacet mₗ is always illuminated (not dimmed by any shadow). The resulting overestimation allows us to compensate for the energy transmitted by further-order reflections (e.g., a third reflection, a fourth reflection, etc.), effectively allowing the result to approach physical reality while still allowing for the geometric term G_{I} to be computed relatively easily. Therefore, the G_{I} term (identified by the number 2) with respect to the asymmetrical microfacet mᵣ is defined as follows:

$${G}_{I} = 1 - max ( 0 , \frac{sin ( {θ}_{vc} - {θ}_{m} )}{sin ( {θ}_{vc} + {θ}_{m} )} )$$

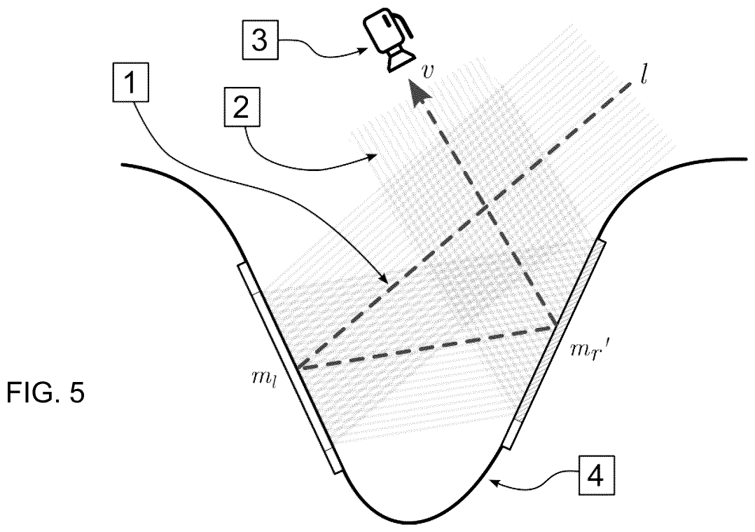

The geometric term G_{I} therefore estimates the light coming from the direction l, reflecting off microfacet mᵣ, reflecting off microfacet mₗ, and then travelling in the direction v of the camera 3. As seen in FIG. 5, the light path is indicted by 1, the light area representing the portion of energy that is reflected by the pair of microfacets in the direction of the observer is indicated by 2, the observer is indicated by 3, and the theoretical irregular surface is indicated by 4.

The term G_{I} may then be applied on top of a standard single-scattering GGX specular lobe. In particular, a multiple scattering specular lobe is composed based on a modified version of the standard CT model, using the term G_{I} with adjusted versions of the normal distribution term D_{I} and the Fresnel term F_{I}, as follows.

$${D}_{I} = \frac{{α}^{2}}{{π ( {cos ( {θ}_{m} )}^{2} ( {α}^{2} - 1 ) + 1 )}^{2}}$$

As for the adjusted Fresnel term, every time light reflects in a material, a small portion of the energy is absorbed, changing the colour of the light. Therefore, in a multiple scattering model, the colour of the material will appear more saturated. This effect is achieved by squaring the F term that was previously computed in the single-reflection lobe, reducing the computation cost.

$${F}_{I} = F \cdot F$$

The full multi-scattering specular lobe is defined as follows:

$${F}_{I} = \frac{{D}_{I} {G}_{I} {F}_{I}}{2 ( c \cdot v )}$$

The multi-scattering specular lobe then added to the single-scattering lobe of a traditional GGX model (FIG. 7).

Generally, the mathematical formulation described herein provides a closed-form solution to the multi-scattering problem. No Monte-Carlo simulation, nor any other sampling method, is required. The results may therefore be free of noise.

Furthermore, since only the first two reflections are considered, the equations used to compute the term G_{I} are simpler and therefore cheaper to compute.

As described above, the V-groove's microfacets are also assumed to be asymmetric in their light transport. This assumption ignores shadowing from the light, effectively overestimating the effect of the second reflection which may compensate for the fact that higher-order reflections are ignored. The resulting visual appearance of the model may therefore be closer to ground truth.

Furthermore, according to some embodiments, the V-groove is not restricted to be aligned with the surface normal n, as in the case of some prior methods. This allows the V-groove to have a free orientation that only depends on the light and view directions as defined by the positions of the light source and the viewer. This may avoid specular artifacts being present when the model is rendered.

Rendering has also become a component of many state-of-the art machine learning-based reconstruction algorithms. The model described herein may therefore be used to achieve improved realism in such applications. For example, the model may be implemented within a differentiable computation framework (e.g., PyTorch).

The model described herein may also be used to design materials that absorb or maximally scatter electromagnetic energy. For example, an existing design may be minimized or maximized with respect to the multi-scattering approximation. This may have applications such as designing pigments that maximally absorb light (i.e., Vanta black) or even military applications which seek to maximally scatter radar signals to avoid detection. Furthermore, the multiple-scattering model described herein may be used to design the microsurface of a material to increase or reduce its reflectivity.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

What is claimed is:

1. A method of rendering a computer model, comprising:
identifying, relative to a macro surface, respective positions of a light source and an observer;
determining, based on the positions of the light source and the observer, respective positions of a first microfacet and a second microfacet, wherein:
a vector c bisects an angle subtended by the first and second microfacets; and
the positions of the first and second microfacets are positions in which, based on multiple orientations of c, light travelling from the light source to the macro surface is reflected by the first microfacet toward the second microfacet, and then by the second microfacet toward the observer;
determining, based on the positions of the first and second microfacets, a multi-scattering factor; and
rendering the computer model based on the multi-scattering factor.

2. The method of claim 1, wherein:
the method further comprises determining, based on the positions of the light source and the observer, a single-scattering factor; and
rendering the model comprises rendering the model based on the single-scattering factor and the multi-scattering factor.

3. The method of claim 2, wherein rendering the model comprises:
determining a sum of the single-scattering factor and the multi-scattering factor; and
rendering the model based on the sum.

4. The method of claim 1, wherein the positions of the first and second microfacets are such that light travelling from the light source to the macro surface is reflected by the first microfacet toward the second microfacet, and then by the second microfacet toward the observer, and is not reflected by any other microfacet.

5. The method of claim 1, wherein:
respective rear surfaces of the first and second microfacets are assumed to be transparent to light such that, for each of the first and second microfacets, light incident on the rear surface is assumed to pass through the microfacet; and
the positions of the first and second microfacets are positions in which light travelling from the light source to the macro surface is reflected by a front surface of the first microfacet toward the second microfacet, and then by a front surface of the second microfacet toward the observer, wherein the front surfaces of the first and second microfacets are opposite the respective rear surfaces of the first and second microfacets.

6. The method of claim 1, wherein determining the multi-scattering factor comprises:
determining D_{I}, G_{I}, and F_{I}, wherein D_{I} is a distribution factor of microfacets on the macro surface, G_{I} is an attenuation factor of microfacets on the macro surface, and F_{I} is a reflectance factor of the macro surface; and
determining the multi-scattering factor is based on D_{I}, G_{I}, and F_{I}.

7. The method of claim 6, wherein determining the multi-scattering factor comprises determining:
$$\frac{{D}_{I} * {G}_{I} * {F}_{I}}{2 {θ}_{vc}}$$
and wherein:
light transmitted from the light source and reflected by the macro surface toward the observer defines a vector v extending from the macro surface and toward the observers; and
θ_{vc} is the angle subtended by c and v.

8. The method of claim 7, wherein:
$${D}_{I} = \frac{{α}^{2}}{{π ( {cos ( {θ}_{m} )}^{2} ( {α}^{2} - 1 ) + 1 )}^{2}}$$
and wherein:
α is a roughness of the macro surface; and
θₘ is half the angle subtended by the first and second microfacets.

9. The method of claim 7, wherein:
$${G}_{I} = 1 - max ( 0 , \frac{sin ( {θ}_{vc} - {θ}_{m} )}{sin ( {θ}_{vc} + {θ}_{m} )} )$$
and wherein:
light transmitted from the light source and reflected by the macro surface toward the observer defines a vector v extending from the macro surface and toward the observer;
θ_{vc} is the angle subtended by c and v; and
θₘ is half the angle subtended by the first and second microfacets.

10. The method of claim 7, wherein:
F_{I}=F²; and
F is a Fresnel reflectance of the macro surface.

11. The method of claim 1, wherein the positions of the first and second microfacets are positions in which, based on the multiple orientations of c, light travelling from the light source to the macro surface is reflected by the first microfacet toward the second microfacet and in a direction parallel to the macro surface, and then by the second microfacet toward the observer.

12. The method of claim 1, wherein the multiple orientations of c consist of all orientations of c.

13. A computing device comprising:
a graphics processing unit; and
a computer-readable medium comprising computer program code configured, when executed by the graphics processing unit, to cause the graphics processing unit to render a computer model, comprising:
identifying, relative to a macro surface, respective positions of a light source and an observer;
determining, based on the positions of the light source and the observer, respective positions of a first microfacet and a second microfacet, wherein:
a vector c bisects an angle subtended by the first and second microfacets; and
the positions of the first and second microfacets are positions in which, based on multiple orientations of c, light travelling from the light source to the macro surface is reflected by the first microfacet toward the second microfacet, and then by the second microfacet toward the observer;
determining, based on the positions of the first and second microfacets, a multi-scattering factor; and
rendering the computer model based on the multi-scattering factor.

14. A method of rendering a computer model, comprising:
identifying, relative to a macro surface, respective positions of a light source and an observer;
determining, based on the positions of the light source and the observer, respective positions of a first microfacet and a second microfacet, wherein:
respective rear surfaces of the first and second microfacets are assumed to be transparent to light such that, for each of the first and second microfacets, light incident on the rear surface is assumed to pass through the microfacet; and
the positions of the first and second microfacets are positions in which light travelling from the light source to the macro surface is reflected from a front surface of the first microfacet toward the second microfacet, and then from a front surface of the second microfacet toward the observer, wherein the front surfaces of the first and second microfacets are opposite the respective rear surfaces of the first and second microfacets;
determining, based on the positions of the first and second microfacets, a multi-scattering factor; and
rendering the computer model based on the multi-scattering factor.

15. The method of claim 14, wherein:
the method further comprises determining, based on the positions of the light source and the observer, a single-scattering factor; and
rendering the model comprises rendering the model based on the single-scattering factor and the multi-scattering factor.

16. The method of claim 15, wherein rendering the model comprises:
determining a sum of the single-scattering factor and the multi-scattering factor; and
rendering the model based on the sum.

17. The method of claim 14, wherein the positions of the first and second microfacets are such that light travelling from the light source to the macro surface is reflected by the first microfacet toward the second microfacet, and then by the second microfacet toward the observer, and is not reflected by any other microfacet.

18. The method of claim 14, wherein determining the multi-scattering factor comprises:
determining D_{I}, G_{I}, and F_{I}, wherein D_{I} is a distribution factor of microfacets on the macro surface, G_{I} is an attenuation factor of microfacets on the macro surface, and F_{I} is a reflectance factor of the macro surface; and
determining the multi-scattering factor is based on D_{I}, G_{I}, and F_{I}.

19. The method of claim 18, wherein determining the multi-scattering factor comprises determining:
$$\frac{{D}_{I} * {G}_{I} * {F}_{I}}{2 {θ}_{vc}}$$
and wherein:
light transmitted from the light source and reflected by the macro surface toward the observer defines a vector v extending from the macro surface and toward the observer;
a vector c bisects an angle subtended by the first and second microfacets; and
θ_{vc} is the angle subtended by c and v.

20. The method of claim 18, wherein:
$${D}_{I} = \frac{{α}^{2}}{{π ( {cos ( {θ}_{m} )}^{2} ( {α}^{2} - 1 ) + 1 )}^{2}}$$
and wherein:
α is a roughness of the macro surface; and
θₘ is half the angle subtended by the first and second microfacets.
